(19) United States
(12) Patent Application Publication
(10) Pub. No.: US 2010/0104158 A1
(43) Pub. Date: Apr. 29, 2010

(54) METHOD AND APPARATUS FOR MATCHING LOCAL SELF-SIMILARITIES

(76) Inventors: Eli Shechtman, Rehovot (IL); Michal Irani, Rehovot (IL)

Correspondence Address: DANIEL J SWIRSKY, 55 REUVEN ST., BEIT SHEMESH, 99544, IL

(21) Appl. No.: 12/519,522

(22) PCT Filed: Dec. 20, 2007
(86) PCT No.: PCT/IL07/01584

§ 371 Date: Nov. 29, 2009

Related U.S. Application Data
(60) Provisional application No. 60/973,810, filed on Sep. 20, 2007.
(60) Provisional application No. 60/938,269, filed on May 16, 2007.
(60) Provisional application No. 60/871,206, filed on Dec. 21, 2006.

(51) Int. Cl. G06K 9/46

(52) U.S. Cl. 382/131; 382/201; 382/165

(57) ABSTRACT

A method includes matching at least portions of first, second signals using local self-similarity descriptors of the signals. The matching includes computing a local self-similarity descriptor for each one of at least a portion of points in the first signal, forming a query ensemble of the descriptors for the first signal and seeking an ensemble of descriptors of the second signal which matches the query ensemble of descriptors. This matching can be used for image categorization, object classification, object recognition, image segmentation, image alignment, video categorization, action recognition, action classification, video segmentation, video alignment, signal alignment, multi-sensor signal alignment, multi-sensor signal matching, optical character recognition, image and video synthesis, correspondence estimation, signal registration and change detection. It may also be used to synthesize a new signal with elements similar to those of a guiding signal synthesized from portions of the reference signal. Apparatus is also included.

### FIELD OF THE INVENTION

The present invention relates to detection of similarities in images and videos.

### BACKGROUND OF THE INVENTION

Determining similarity between visual data is necessary in many computer vision tasks, including object detection and recognition, action recognition, texture classification, data retrieval, tracking, image alignment, etc. Methods for performing these tasks are usually based on representing images using some global or local image properties, and comparing them using some similarity measure.

The relevant representations and the corresponding similarity measures can vary significantly. Images are often represented using dense photometric pixel-based properties or by compact region descriptors (features) often used with interest point detectors. Dense propel ties include raw pixel intensity or color values (of the entire image, of small patches as in Wolf et al. (Patch-based texture edges and segmentation. ECCV, 2006) and in Boiman et al. (Detecting irregularities in images and in video. ICCV, Beijing, October, 2005), or fragments as in Ullman et al, (A fragment-based approach to object representation and classification. Proc. 4th International Workshop on Visual Form, 2001), texture filters as in Malik et al. (Textons, contours and regions: Cue integration in image segmentation. ICCV, 1999), or other filter responses as in Schiele et al. (Recognition without correspondence using multidimensional receptive field histograms. IJCV, 2000).

Common compact region descriptors include distribution based descriptors (e.g., SIFT (scale invariant feature transform), as in Lowe (Distinctive Image features from scale-invariant keypoints. IJCV, 60(2):91-110, 2004), differential descriptors (e.g., local derivatives as in Laptev et al. (Space-time interest points. ICCV, 2003), shape-based descriptors using extracted edges (e.g. Shape Context as in Belongie et al. (Shape matching and object recognition using shape contexts. PAMI, 24(4), 2002), and others. Mikolajczyk, (A performance evaluation of local descriptors. PAMI, 27(10):1615-1630, 2005) provides a comprehensive comparison of many region descriptors for image matching.

Although these descriptors and their corresponding measures vary significantly, they all share the same basic assumption, i.e., that there exists a common underlying visual unit (i.e., descriptor type, whether pixel colors, SIFT descriptors, oriented edges, etc.) which is shared by the two images (or sequences), and can therefore be extracted and compared across images/sequences.

This assumption, however, may be too restrictive, as illustrated in FIG. 1, reference to which is now made. Although there is no obvious image property shared between images H1, H2, H3 and H4 shown in FIG. 1, it will be apparent to a casual observer that the shape of a heart appears in each image.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of four images showing a heart;

FIG. 2 is a schematic illustration of a similarity detector operating on image input;

FIG. 3 is a schematic illustration showing elements of the similarity detector of FIG. 2;

FIG. 4 is an illustration showing the process performed by the similarity detector of FIG. 2 to generate local self-similarity descriptors for images;

FIG. 5 is an illustration showing the process performed by the similarity detector of FIG. 2 to generate local self-similarity descriptors for video sequences;

FIGS. 6 and 7 are graphical illustrations showing the operation of the similarity detector of FIG. 2 on one image using an image and a sketch, respectively, as templates;

FIG. 8 is a schematic illustration of the operation of the similarity detector of FIG. 2 on sketches; and

FIG. 9 is a schematic illustration of an imitation unit using the similarity detector of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

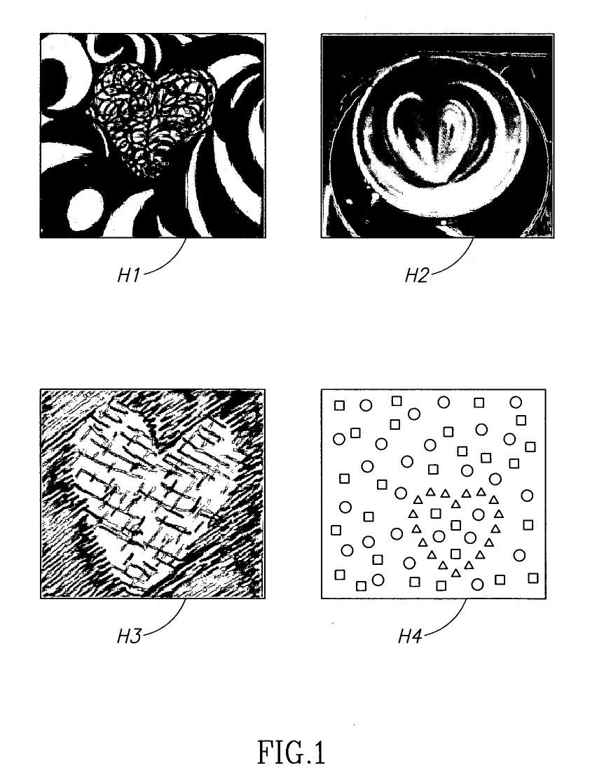

Applicants have realized that the shape of a heart may be discerned in images H1, H2, H3 and H4 of FIG. 1, despite the fact that patterns of intensity, color, edges, texture, etc. across these images are very different and the fact that there is no obvious image property shared between the images. The shape may be discerned because local patterns in each image are repeated in nearby image locations in a similar relative geometric layout. In other words, the local internal layouts of self-similarities are shared by these images, even though the patterns generating those self-similarities are not shared by the images.

The present invention may therefore provide a method and an apparatus for measuring similarity between visual entities (i.e., images or videos) based on matching internal self-similarities. In accordance with the present invention, a novel “local self-similarity descriptor”, measured densely throughout the visual entities, at multiple scales, while accounting for local and global geometric distortions, may be utilized to capture the internal self-similarities of visual entities in a compact and proficient manner. The internal layout of local self-similarities (up to some distortions) may then be compared across images or video sequences, even though the patterns generating those local self-similarities may be quite different in each of the images/videos.

The present invention may therefore be applicable to object detection, retrieval and action detection. It may provide matching capabilities for complex visual data, including detection of objects in real cluttered images using only rough hand-drawn sketches, handling of textured objects having no clear boundaries, and detection of complex actions in cluttered video data with no prior learning.

Self-similarity may be related to the notion of statistical co-occurrence of pixel intensities across images, captured by Mutual Information (MI), as discussed in the article by P. Viola and W. W. III: Alignment by maximization of mutual information. In ICCV, pages 16-23, 1995. Alternatively, internal joint pixel statistics are often computed and extracted from individual images and then compared across images (see the following articles:

R. Haralick, et al. Textural features for image classification. IEEE T-SMC, 1973.

N. Jojic and Y. Caspi. Capturing image structure with probabilistic index maps. In CVPR, 2004.

C. Stauffer and W. E. L. Grimson. Similarity templates for detection and recognition. In CVPR, 2001.)

Most of these methods are restricted to measuring statistical co-occurrence of pixel-wise measures (intensities, color, or simple local texture properties), and are not easily extendable to co-occurrence of larger more meaningful patterns such as image patches. Moreover, statistical co-occurrence is assumed to be global, which assumption is often invalid. Some of these methods further require a prior learning phase with many examples.

Other kinds of patch based self-similarity properties may have been used in signal processing, computer vision and graphics, such as for texture edge detection in images using patch similarities (L. Wolf, et al. Patch-based texture edges and segmentation, in ECCV, 2006); for detecting symmetries (G. Loy and J.-O. Eklundh. Detecting symmetry and symmetric constellations of features, in ECCV, 2006); for Fractal Image Compression (as in Fractal Image Compression: Theory and Application, Yuval Fisher (editor), Springer Verlag, New York, 1995, where an image is compressed by finding self-similar patches within an image at multiple scales and orientations and encoding them together); for gait recognition in video (C. BenAbdelkader et al., Gait recognition using image self-similarity. EURASIP Journal on Applied Signal Processing, 2004(4), where self-similarity of video frames with their neighboring frames was used to generate patterns for identifying a persons gait); for image denoising (A. Buades, B. Coll, and J. M. Morel, “A Non Local Algorithm for Image Denoising”, in CVPR '05, who computed an SSD-based self-similarity map of a patch to the entire image and used this map as the averaging weights for denoising) and for 3D shape compression (Erik Hubo, Tom Mertens, Tom Haber and Philippe Bekaert, “Self Similarity-Based Compression of Point Clouds, with Application to Ray Tracing”, in IEEE/EG Symposium on Point-Based Graphics 2007, that describe a system to compress 3D shapes by finding and clustering local self-similar 3D surface patches). Finally, auto-correlation operations, which correlate a small portion of a signal against the entire signal, may also find self-similar areas in the signal. Auto-correlation is used to find the repetitiveness and frequency content of a signal. The above methods use patch self-similarity properties to analyze or manipulate a single visual entity or signal.

In the present invention, self-similarity based descriptors are used for matching pairs of visual entities or signals. Self-similarities may be measured only locally (i.e. within a surrounding region) rather than globally (i.e. within the entire image or signal). The present invention models local and global geometric deformations of self-similarities and uses patches (or descriptors of patches) as the basic unit for measuring internal self-similarities. For images, patches may capture more meaningful image patterns than do individual pixels.

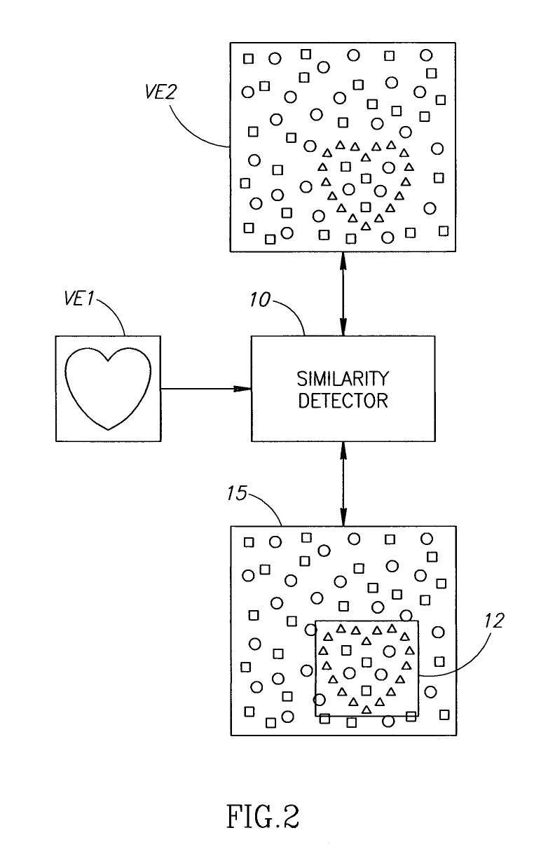

FIG. 2, reference to which is now made, shows a similarity detector 10 constructed and operative in accordance with the present invention. As shown in FIG. 2, similarity detector 10 may be employed in accordance with the present invention to compare one visual entity VE1 with another visual entity VE2. Visual entity VE1 may be a “template” image F(x, y) (or a video clip F(x,y,t)), and visual entity VE2 may be another image G(x,y) (or video G(x,y,t)). Visual entities VE1 and VE2 may not be of the same size. In fact, in most practical exemplary cases, F may be a small template (of an object or action of interest), which is searched for within a larger G (a larger image, a longer video sequence, or a collection of images/videos).

In the example of FIG. 2, first visual entity VE1 is a hand-sketched image of a heart shape, and second visual entity VE2 is image H4 of FIG. 1, in which a heart-shaped configuration of triangles is embedded among a scattering of circles and squares of the same size as the triangles forming the heart shape. As shown in FIG. 2, similarity detector 10 may detect the heart shape formed by the triangles, as shown in output 15, where the heart-shape formed by the triangles in visual entity VE2 (image H4 of FIG. 1) is outlined by square 12.

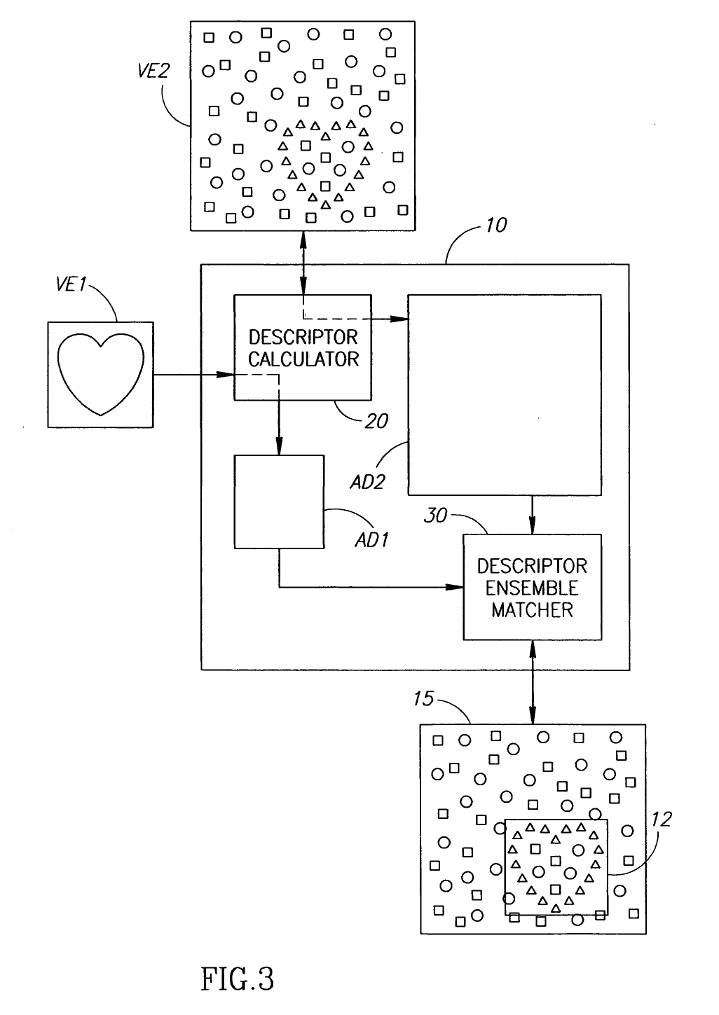

The operation of similarity detector 10 of FIG. 2 is explained in further detail with respect to FIG. 3, reference to which is now made. As shown in FIG. 3, similarity detector 10 may comprise a descriptor calculator 20 and a descriptor ensemble matcher 30 in accordance with the present invention. In the first method step performed by similarity detector 10, descriptor calculator 20 may compute local self-similarity descriptors d_{q} densely (e.g., every 5th pixel q) throughout visual entities VE1 and VE2, typically by scanning through visual entities VE1 and VE2. Descriptor calculator 20 may thus produce an array of descriptors AD for each visual entity VE1 and VE2, shown in FIG. 3 as arrays AD1 and AD2 respectively.

It will be appreciated that array of local descriptors AD1 may constitute a single global “ensemble of descriptors” for visual entity VE1, which may maintain the relative geometric positions of its constituent descriptors. As shown in FIG. 3, descriptor ensemble matcher 30 may search for ensemble of descriptors AD1 in visual descriptor array AD2. In accordance with the present invention, similarity detector 10 may find a good match of VE1 in VE2 when descriptor ensemble matcher 30 finds an ensemble of descriptors in AD2 which is similar to ensemble of descriptors AD1.

In the example shown in FIG. 3 it may be seen that the ensemble of descriptors in AD2 found by descriptor ensemble matcher 30 to be similar to ensemble of descriptors AD1 corresponds to the heart shape formed by the triangles in visual entity VE2 (image H4 of FIG. 1), as indicated by the clouding in output 15, as previously shown in FIG. 1.

In accordance with the present invention, descriptor calculator 20 may calculate a descriptor d_{q} for a pixel q by correlating an image patch Pq centered at q with a larger surrounding image region Rq also centered at q. An exemplary size for image patch Pq may be 5×5 pixels and an exemplary size for region Rq may be a 40-pixel radius. The correlation of Pq with Rq may result in a local internal correlation surface Scorq.

It will be appreciated that the term “local” indicates that patch Pq is correlated to a small portion (e.g., 5%) of visual entity VE, rather than the entire visual entity VE. Thus the “local” self-similarity descriptor, which is derived from this “local” correlation, as will be explained in further detail hereinbelow, is equipped to describe “local” self-similarities in visual entities.

It will further be appreciated that for visual entities having a time component, i.e. videos, the result of the correlation of Pq with Rq may be a correlation volume Vcorq rather than a correlation surface Scorq.

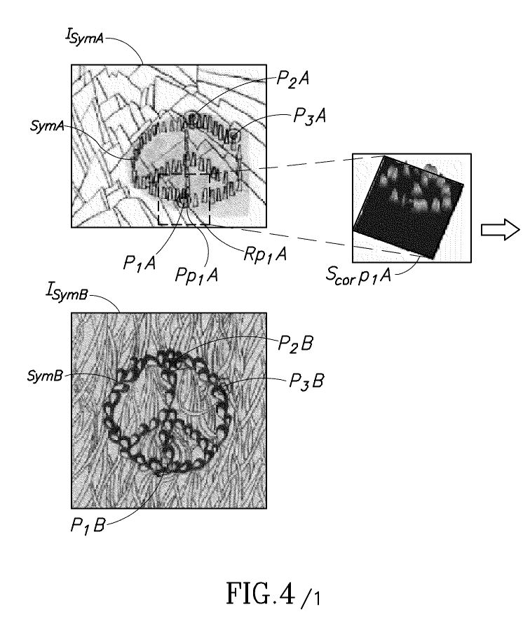

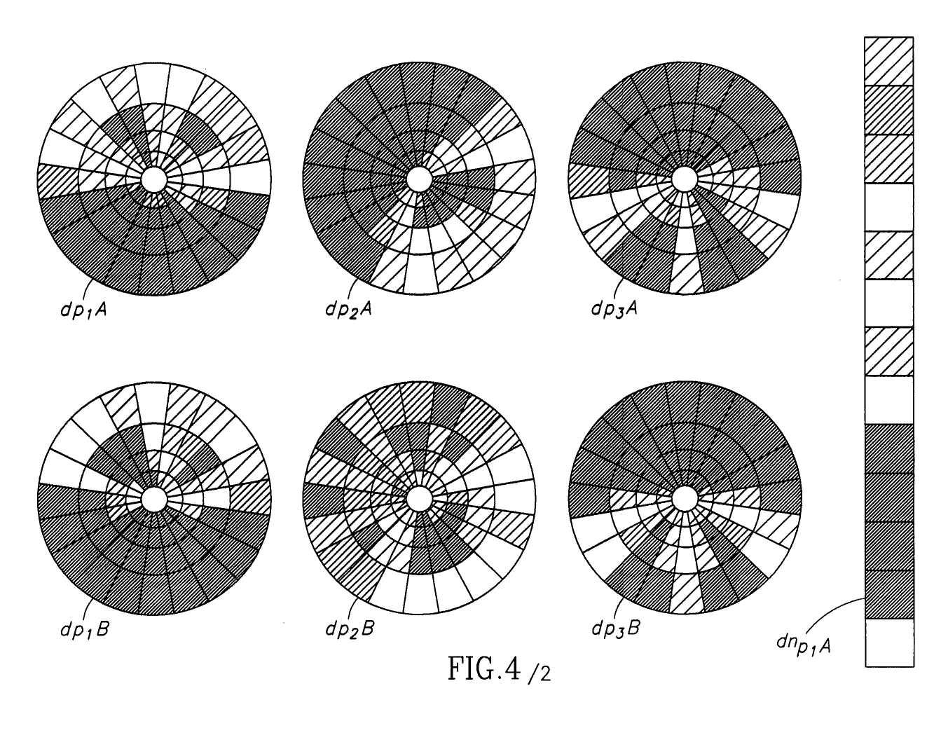

The operation of descriptor calculator 20 of FIG. 3 is explained in further detail with respect to FIG. 4, reference to which is now made. Exemplary patch Pp1A and exemplary region Rp1A are shown to be centered at point p1A, which is located at 6 o'clock on the peace symbol SymA shown in image I_{SymA}. The exemplary correlation surface S_{cor}p1A resulting from the correlation of exemplary patch Pp1A with exemplary region Rp1A is also shown in FIG. 4.

In accordance with the present invention, descriptor calculator 20 may transform correlation surface S_{cor}q into a binned, radially increasing polar form, similar to a binned log-polar form. A similar representation was used by Belongie et al. (Shape matching and object recognition using shape contexts. PAMI, 24(4), 2002). The representation for correlation surface S_{cor}q may be d_{q}, the local self similarity descriptor provided in the present invention.

The local self similarity descriptors dₚ_{₁}_{A}, dₚ_{₂}_{A}, and dₚ_{₃}_{A} are shown in FIG. 4 for points p1A, p2A and p3A respectively. Point p1A is located at 6 o'clock on the peace symbol SymA shown in image I_{SymA}, as stated previously hereinabove, and points p2A and p3A are located at 12 o'clock and 2 o'clock respectively on peace symbol SymA.

An additional exemplary image I_{SymB} containing the likeness of a peace symbol is also shown in FIG. 4. Despite the geometric similarity which may be observed between the peace symbols SymA and SymB, it may be seen that there is a large difference in photometric properties between images I_{SymA} and I_{SymB}. FIG. 4 further shows descriptors dₚ_{₁}_{B}, dₚ_{₂}_{B}, and dₚ_{₃}_{B} for points p1B, p2B and p3B respectively, whose locations on peace symbol SymB at 6 o'clock, 12 o'clock and 2 o'clock respectively, correspond to the locations of points p1A, p2A and p3A respectively on peace symbol SymA.

It will be appreciated that the evident similarity between the descriptors of corresponding points in images I_{SymA} and I_{SymB}, (i.e. dₚ_{₁}_{A} and dₚ_{₁}_{B}, dₚ_{₂}_{A} and dₚ_{₂}_{B}, and dₚ_{₃}_{A} and dₚ_{₃}_{B}) which may be observed in FIG. 4, demonstrates the facility of the descriptors provided in the present invention to expose geometrically similar entities in images despite significant differences in photometric properties between those images.

It will therefore be appreciated that the method provided in the present invention may allow similarity detector 10 to see beyond the superficial trappings (e.g., particular colors, patterns, edges, textures, etc.) of an image, to its underlying shapes of regions of similar properties. The descriptor calculation process performed by descriptor calculator 20 may, by highlighting locations of internal self-similarities in the image, remove the camouflages from the shapes in the image. Then, once descriptor calculator 20 has exposed the shapes hidden in the image, descriptor ensemble matcher 30 may have a straightforward task finding similar shapes in other images.

Returning now to the operation of descriptor calculator 20 of FIG. 3, it will be appreciated that descriptor calculator 20 may perform the correlation of patch Pq with larger surrounding image region Rq using any suitable similarity measure. In accordance with one embodiment of the present invention, descriptor calculator 20 may use a simple sum of squared differences (SSD) between patch colors in some color space, e.g., L*a*b* color space. The resulting distance surface SSDq(x,y) may be normalized and transformed into correlation surface S_{cor}q, where S_{cor}q(x,y) is given by the following equation:

$${S}_{cor} q ( x , y ) = exp ( - \frac{{SSD}_{q} ( x , y )}{max ( {var}_{noise} , {var}_{auto} ( q ) )} )$$

where varₙₒᵢₛₑ is a constant that corresponds to acceptable photometric variations (in color, illumination or due to noise), and varₐᵤₜₒ(q) takes into account the patch contrast and its pattern structure, such that sharp edges are more tolerable to pattern variations than smooth patches. For example, varₐᵤₜₒ(q) may be computed by examining the auto-correlation surface in a small region (of radius 1) around q or it may be the maximal variance of the difference of all patches within a very small neighborhood of q (of radius 1) relative to the patch centered at q.

Other suitable similarity measures may include the sum of absolute difference (SAD), a Mahalanobis distance, a correlation, a normalized correlation, mutual information, a distance measure between empirical distributions, and a distance measure between common local region descriptors. Moreover, instead of the patches themselves, the present invention may describe each patch and region with local signal descriptors, which may be intensity values, color representation values, gradient values, filter responses, SIFT descriptors, histograms of filter responses, Gaussian blur descriptors and empirical distributions of features.

In accordance with the present invention, descriptor calculator 20 may then transform correlation surface S_{cor}q into a binned, radially increasing polar form, similar to a binned log-polar form, through translation into log-polar coordinates centered at q, and partitioning into a multiplicity X (e.g. 80) bins. It may then select the maximal correlation value in each bin, forming the X entries of local self-similarity descriptor d_{q} associated with pixel q. Finally, descriptor calculator 20 may normalize the descriptor vector, such as by L1 normalization, L2 normalization, normalization by standard deviation or by linearly stretching its values to the range of [0,1] in order to be invariant to the differences in pattern and color distribution of different patches and their surrounding image regions. The normalized form d_{nq} of descriptor d_{q} is shown in FIG. 4 for point p1A, and is denoted dnₚ_{₁}_{A}.

It will be appreciated that the local self-similarity descriptor provided in the present invention has the following properties and benefits:

Firstly, it may treat self-similarities as a local image property, and accordingly may measure them locally (within a surrounding image region) and not globally (within the entire image). This extends the applicability of the descriptor to a wide range of challenging images.

Secondly, the generally log-polar representation may account for local affine deformations in the self-similarities.

Thirdly, owing to the selection of the maximal correlation value in each bin, the descriptor may be insensitive to the exact position of the best matching patch within that bin (similar to the observation used for brain signal modeling, e.g. as in Serre et al. (Robust object recognition with cortex-like mechanisms. PAMI, 2006). Since the bins increase in size with the radius, this allows for additional radially increasing non-rigid deformations.

Finally, the use of patches (at different scales) as the basic unit for measuring internal self-similarities captures more meaningful image patterns than individual pixels. It treats colored regions, edges, lines and complex textures in a single unified way. A textured region in one image may be matched with a uniformly colored region or a differently textured region in a second image, as long as they have a similar spatial layout (i.e. similar shapes). Differently textured regions with unclear boundaries may be matched to each other.

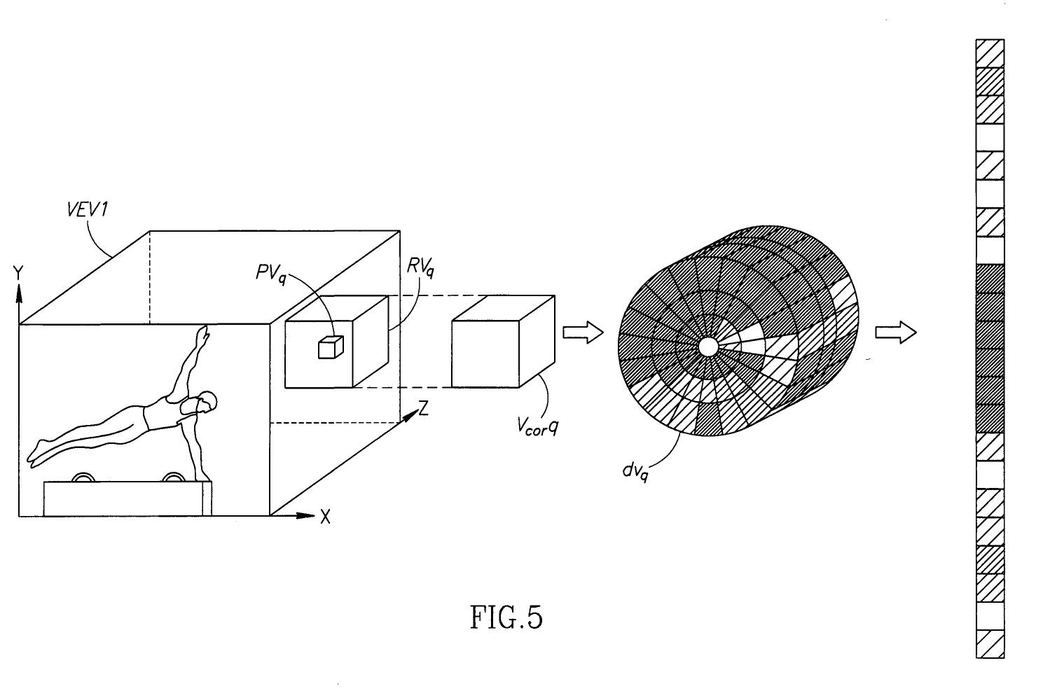

It will be appreciated that the visual entities processed by similarity detector 10 may be two-dimensional visual entities, i.e., images, as in the examples of FIGS. 1-4, or three-dimensional visual entities, i.e., videos, as in the example of FIG. 5, reference to which is now made. Applicants have realized that the notion of self similarity in video sequences is even stronger than in images. For example, people wear the same clothes in consecutive frames, and backgrounds tend to change gradually, resulting in strong self-similar patterns in local space-time video regions. As shown in FIG. 5, exemplary video VEV1, showing a gymnast exercising on a horse, exists in three-dimensional space, having a z-axis representing time in addition to the x and y axes representing the two-dimensional space of images. It may be seen in FIG. 5 that for three-dimensional visual entities VEV processed in the present invention, patches Pq and regions Rq become three-dimensional space-time entities PVq and RVq respectively. It may further be seen that the result of the correlation of a space-time patch PVq with a space-time region RVq results in a correlation volume V_{cor}q rather than a correlation surface S_{cor}q. The self-similarity descriptor dq provided in the present invention may also be extended into space-time for three-dimensional visual entities.

It will be appreciated that the space-time video descriptor dv_{q} may account for local affine deformations both in space and in time (thus also accommodating small differences in speed of action). In the transformation of the correlation volume V_{cor}q to a compact representation, correlation volume V_{cor}q may be transformed to a binned representation which is linearly increasing in time. For example, intervals both in space and in time may be logarithmic, while intervals in space may be polarly represented. For this example, V_{cor}q may be a cylindrically shaped volume, as shown in FIG. 5. In one example, 5×5×1 pixel sized patches PVq and 60×60×5 pixel sized regions RVq were used.

It will be appreciated that the present invention may be performed, not just on images or video sequences, but on one-dimensional and multi-dimensional signals as well. For example, magnetic resonance imaging (MRI) signals are four-dimensional.

Returning now to the operation of descriptor ensemble matcher 30 of FIG. 3, as stated previously hereinabove, it will be appreciated that similarity detector 10 may find a good match of VE1 in VE2 when descriptor ensemble matcher 30 finds an ensemble of descriptors in AD2 which is similar to ensemble of descriptors AD1. In accordance with the present invention, similar ensembles of descriptors in AD1 and AD2 may be similar both in descriptor values and in their relative geometric positions (up to small local shifts, to account for small global non-rigid deformations). Alternatively, the ensemble may be an empirical distribution of descriptors or of a set of representative descriptors, also called the “Bag of Features” method (e.g., S. Lazebnik, C. Schmid and Jean Ponce, “Beyond bags of features: Spatial pyramid matching for recognizing natural scene categories”, IEEE CVPR pages 2169-2178, 2006), usually utilized for object and scene classification. Other ensembles may be defined using quantized representations of the descriptors, a subset of the descriptors or geometric layouts of the descriptors. It will be appreciated that the ensemble may contain one or more descriptors.

However, since the descriptors in an ensemble may not all be informative, descriptor ensemble matcher 30 may, in accordance with the present invention, first filter out non-informative descriptors. One type of non-informative descriptor is that which does not capture any local self-similarity (i.e., whose center patch is salient, not similar to any of the other patches in its surrounding image/video region). Another type of non-informative descriptor is that which contains high self-similarity everywhere in its surrounding image region (corresponding to a large homogeneous region, i.e., a large uniformly colored or uniformly-textured image region).

In accordance with the present invention, the former type of non-informative descriptors (i.e., representing saliency) may be detected as descriptors whose entries are all below some threshold, before the descriptor vector is normalized to 1. The latter type of non-informative descriptors (i.e., representing homogeneity) may be detected by employing a sparseness measure (e.g. entropy or the measure of Hoyer (Non-negative matrix factorization with sparseness constraints. Journal of Machine Learning Research. 5:1457-1469, 2004)).

It will be appreciated that the step of discarding non-informative descriptors is important in avoiding ambiguous matches. Furthermore, it will be appreciated that despite the fact that some descriptors are discarded, the remaining descriptors still form a dense collection.

Descriptor ensemble matcher 30 may learn the set of informative descriptors and their locations from a set of examples or templates of an object class, in accordance with standard object recognition methods. The following articles describe exemplary methods to learn the set of informative descriptors:

S. Ullman, E. Sali, M. Vidal-Naquet, A Fragment-Based Approach to Object Representation and Classification, Proc. 4th International Workshop on Visual Form (IWVF4), Capri, Italy, 2001;

R. Fergus, P. Perona and A. Zissennan, “Object Class Recognition by

Unsupervised Scale-Invariant Learning”, Proceedings of the IEEE Conference on Computer Vision and Pattern Recognition, June 2003;

B. Leibe and B. Schiele, Interleaved Object Categorization and Segmentation, British Machine Vision Conference (BMVC'03), September 2003.

In accordance with the present invention, descriptor ensemble matcher 30 may find a good match of VE1 in VE2 using a modified version of the “ensemble matching” algorithm of Boiman et al., also described in PCT application PCT/IL2006/000359, filed Mar. 21, 2006, assigned to the common assignees of the present invention and incorporated herein by reference. This algorithm may employ a simple probabilistic “star graph” model to capture the relative geometric relations of a large number of local descriptors.

In accordance with the present invention, all of the descriptors in the template VE1 may be connected into a single ensemble of descriptors, and descriptor ensemble matcher 30 may employ the search method of PCT/IL2006/000359 for detecting a similar ensemble of descriptors within VE2, allowing for some local flexibility in descriptor positions and values. Matcher 30 may use a sigmoid function on the x² or L1 distance to measure the similarity between descriptors. Descriptor ensemble matcher 30 may thus generate a dense likelihood map the size of VE2, corresponding to the likelihood of detecting VE1 (or the center of the star model) at each and every point in VE2. Locations in VE2 with high likelihood may be locations in VE2 where VE1 is detected.

Alternatively, descriptor ensemble matcher 30 may search for similar objects using a “Bag of Features” method. Such a method matches statistical distributions of self-similarity descriptors or distributions of representative descriptors using a clustering pre-process.

Because self-similarity may appear at various scales and in different region sizes, similarity detector 10 may extract self-similarity descriptors at multiple scales. In the case of images, a Gaussian image pyramid may be used; in the case of video data, a space-time video pyramid may be used. Parameters such as patch size, surrounding region size, etc., may be the same for all scales. Thus, the physical extent of a small 5×5 patch in a coarse scale may correspond to the extent of a large image patch at a fine scale.

Similarity detector 10 may generate and search for an ensemble of descriptors for each scale independently, generating its own likelihood map. To combine information from multiple scales, similarity detector 10 may first normalize each log-likelihood map by the number of descriptors in its scale (these numbers may vary significantly from scale to scale). Similarity detector 10 may then combine the normalized log-likelihood surfaces using a weighted average, with weights corresponding to the degree of sparseness (such as in Hoyer) of these log-likelihood surfaces.

It will be appreciated that the present invention may be implemented to detect objects of interest in cluttered images. Given a single example image of an object of interest, i.e. a “template image”, descriptor calculator 20 of similarity detector 10 may densely compute its local image descriptors dq as described hereinabove with respect to FIGS. 3 and 4, and may generate an “ensemble of descriptors”. Then, descriptor ensemble matcher 30 may search for this template-ensemble in one or more cluttered images.

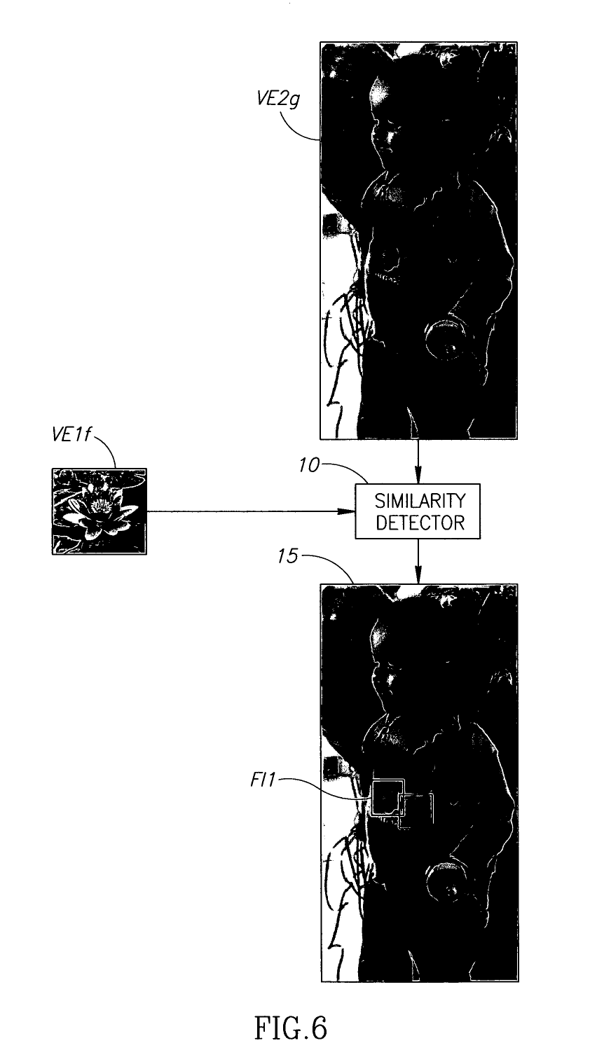

FIG. 6, reference to which is now made, shows similarity detector 10 of FIG. 2, where visual entity VE1 is an exemplary template image VE1f of a flower, and visual entity VE2 is an exemplary cluttered image VE2g. In accordance with the present invention as described hereinabove, similarity detector 10 may detect flower image FI1 in cluttered image VE2g as shown in output 15. The flower images in cluttered image VE2g which similarity detector 10 may detect to be similar to flower image FI1 are indicated by a square in output 15.

In accordance with the present invention, for detection of a single template image in multiple cluttered images, the threshold distinguishing low likelihood values from high likelihood values (used to determine detection of the template image) may remain the same for all of the multiple cluttered images in which a search for the single template image is conducted. For different template images, the threshold may be varied.

It will be appreciated that, for the detection of objects in cluttered images in accordance with the present invention as described hereinabove, no prior image segmentation nor any prior learning may be required.

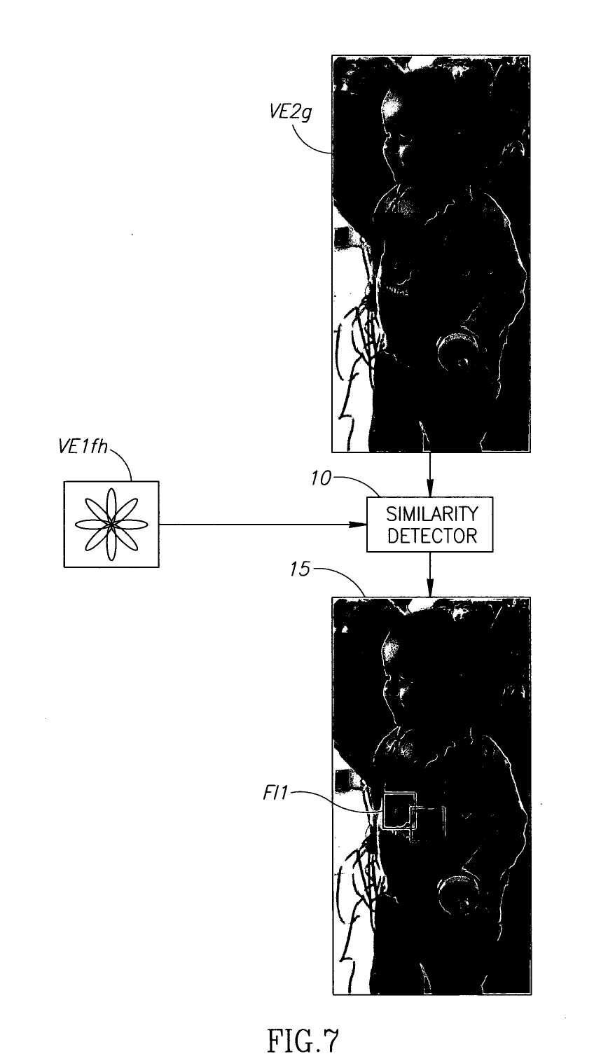

It will further be appreciated that the method described hereinabove for object detection in cluttered images may be operable for real image templates, as well as hand sketched image templates. FIG. 7, reference to which is now made, shows similarity detector 10 and exemplary cluttered image VE2g of FIG. 6. In FIG. 7, exemplary template image VE1fh is a sketch of a flower roughly drawn by hand rather than a real image of a flower. As shown in output 15 of FIG. 7, which is generally similar to output 15 of FIG. 6, similarity detector 10 may succeed in detecting flower image FI1 in cluttered image VE2g whether visual entity VE1 is a real template image, such as image VE1f of FIG. 6, or a hand-sketched image, such as image VE1fh of FIG. 7.

It will be appreciated that while hand-sketched templates may be uniform in color, such a global constraint may not be imposed on the searched objects. This is because the self-similarity descriptor tends to be more local, imposing self-similarity only within smaller object regions. The method provided in the present invention may therefore be capable of detecting similarly shaped objects with global photometric variability (e.g., people with pants and shirts of different colors, patterns, etc.)

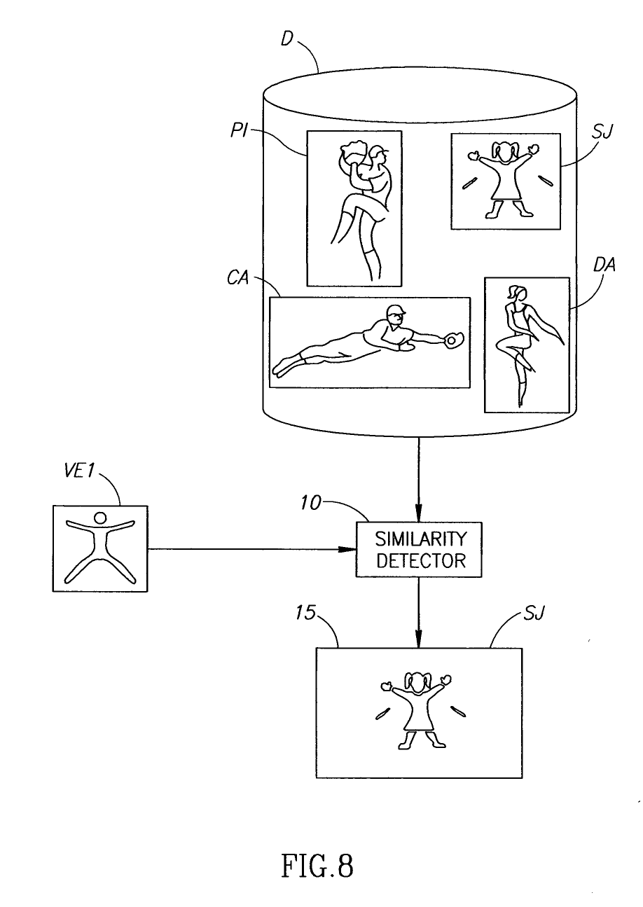

The present invention may further provide a method to retrieve images from a database of images using rough hand-sketched queries. FIG. 8, reference to which is now made, shows similarity detector 10 of FIG. 2, where visual entity VE1 is a rough hand-sketch of an exemplary complex human pose, a “star-jump”, in which pose a person jumps with their arms and legs outstretched. In accordance with the present invention, similarity detector 10 may search the images in an image database D for the pose shown in visual entity VE1. As shown in output 15, similarity detector 10 may detect that image SJ of database D shows a person in the star-jump pose. Images PI, CA and DA of database D, showing a person in poses of pitching, catching and dancing respectively, do not contain the star-jump pose shown in visual entity VE1 and are therefore not detected by similarity detector 10.

The present invention may be utilized to detect human actions or other dynamic events using an animation or a “dynamic sketch”. These could be generated by an animator by hand or with graphics animation software. The animation or dynamic sketch may provide an input space-time query and the present invention may attempt to match it to real video sequences in database 20.

It will be appreciated that the method provided in the present invention as described hereinabove with respect to FIG. 8 may detect a query pose in database images notwithstanding cluttered backgrounds or high geometric and photometric variability between different instances of each pose.

It will further be appreciated that unlike prior art methods for image retrieval using image sketches, as in Jacobs et al. (Fast multiresolution image querying. In SIGGRAPH, 1995) and Hafner et al. (Efficient color histogram indexing for quadratic form distance. PAMI, 17(7), 1995), the method provided in the present invention is not limited by the assumption that the sketched query image and the database images share similar low-resolution photometric properties (colors, textures, low-level wavelet coefficients, etc. Instead, self-similarity descriptors may capture both edge and local regions (of uniform color or texture or repetitive patterns) and thus, generally do not suffer from ambiguities.

It will further be appreciated that the sketch need not be the template. The present invention may also use an image as a template to find a sketch, or a portion of a sketch, from the database. Similarly, the present invention may utilize a video sequence to find an animated sequence.

The present invention may further provide a method, using the space-time self-similarity descriptors dv_{q} described hereinabove, to simultaneously detect multiple complex actions in video sequences of different people wearing different clothes with different backgrounds, without requiring any prior learning (i.e., based on a single example clip).

The present invention may further provide a method for face detection. Given an image or a sketch of a face, similarity detector 10 may find a face or faces in other images or video sequences.

The self similarity descriptors provided in the present invention may also be used to detect matches among signals and images in medical applications. Medical applications of the present invention may include EEG (electroencephalography), bone densitometry, cardiac cine-loops, coronary angiography/ateriography, CT (computed tomography) scans, CAT (computed axial tomography) scans, EKG (echocardiograph), endoscopic images, mammography/mammogram, MRA (magnetic resonance angiography), MRI (magnetic resonance imaging), PET (positron emission tomography) scans, single image X-rays and ultrasound.

For one-dimensional signals, similarity detector 10 may take a short local segment of the signal around a given point r and correlate the local segment against a larger segment around point r. Similarity detector 10 may then sample the auto-correlation function using a “max” operator and generating bins where the size of the bins increases with their distance from point r.

The self similarity descriptors provided in the present invention may also be used to perform “correspondence estimation” between two signals. Applications may include the alignment of two signals, or portions of signals, recovery of point correspondences, and recovery of region correspondences. It will further be appreciated that these applications may be performed both in space and in space-time.

The present invention may also detect changes between two or more images of the same scene (e.g. aerial, satellite or medical images), where the images may be of different modalities, and/or taken at different times (days, months or even years apart). It may also be applied to video sequences.

The method may first align the images (using a method based on the self-similarity descriptors or on a different method), after which it may compute the self-similarity descriptors on dense grids of points in both images at corresponding locations. The method may compute the similarity (or dissimilarity) between pairs of corresponding descriptors at each grid point. Locations with similarity below some relatively low threshold may be declared as changes.

In another embodiment, the size and shape of the patches may be different, resulting in different types of correlation surfaces. The patches are of sizes W×H, for images, or W×H×T for video sequences, and may have K channels of data. For example, one channel of data may be the grey-level intensities while three channels may provide the color space data (RGB, L*a*b*, etc.) If there are more than three channels, then these might be multi-spectral channels, hyper-spectral channels, etc.

For example, if H=3 and W=7, then the correlation is of a horizontal rectangle; if H=5 and W=1 then the correlation is of a vertical line segment; if H=W=1 and T=3 then the correlation is of a temporal intensity profile of a pixel (measuring some local temporal phenomenon).

If H=W=T=1, which marks a single pixel, then the data being compared might not be an image or a video sequence but might be some other kind of data. For example, it might be Gabor filters, Gaussian derivative filters, steerable filters, difference of rectangles filters (such as those described in the article by P. Viola, M. Jones, “Rapid object detection using a boosted cascade of simple features”, CVPR 2001), textons, high order local derivatives, SIFT descriptor or other local descriptors.

It will be appreciated that similarity detector 10 may be utilized in a wide variety of signal processing tasks, some of which have been discussed hereinabove but are summarized here. For example, detector 10 may be used to retrieve images using only a rough sketch of an object or of a human pose of interest or using a real image of an object of interest. Such image retrieval may be for small or large databases, where the latter may effect a data-mining operation. Such large databases may be digital libraries, video streams and/or data on the internet. Detector 10 may be used to detect objects in images or to recognize and classify objects. It may be used to detect faces and/or body poses.

As discussed hereinabove, similarity detector 10 may be used for action detection. It may be used to index video sequences and to cluster or group images or videos. Detector 10 may find interesting patterns, such as lesions or breaks, on medical images and it may match sketches (such as maps, drawings, diagrams, etc). For the latter, detector 10 may match a diagram of a printed board, a schematic sketch or map, a road/city map, a cartoon, a painting, an illustration, a drawing of an object or a scene layout to a real image, such as a satellite image, aerial imagery, images of printed boards, medical imagery, microscopic imagery, etc.

Detector 10 may also be used to match points across images that have captured the same scene but from very different angles. The appearance of corresponding locations across the images might be very different but their self-similarity descriptors may be similar.

Furthermore, detector 10 may be utilized for character recognition (i.e. recognition of letters, digits, symbols, etc.). The input may be a typed or handwritten image of a character and similarity detector 10 may determine where such a character exists on a page. This process may be repeated until all the characters expected on a page have been found. Alternatively, the input may be a word or a sentence and similarity detector 10 may determine where such word or sentence exists in a document.

It will be appreciated that detector 10 may be utilized in many other ways, including image categorization, object classification, object recognition, image segmentation, image alignment, video categorization, action recognition, action classification, video segmentation, video alignment, signal alignment, multi-sensor signal alignment, multi-sensor signal matching, optical character recognition, correspondence estimation, registration and change-detection.

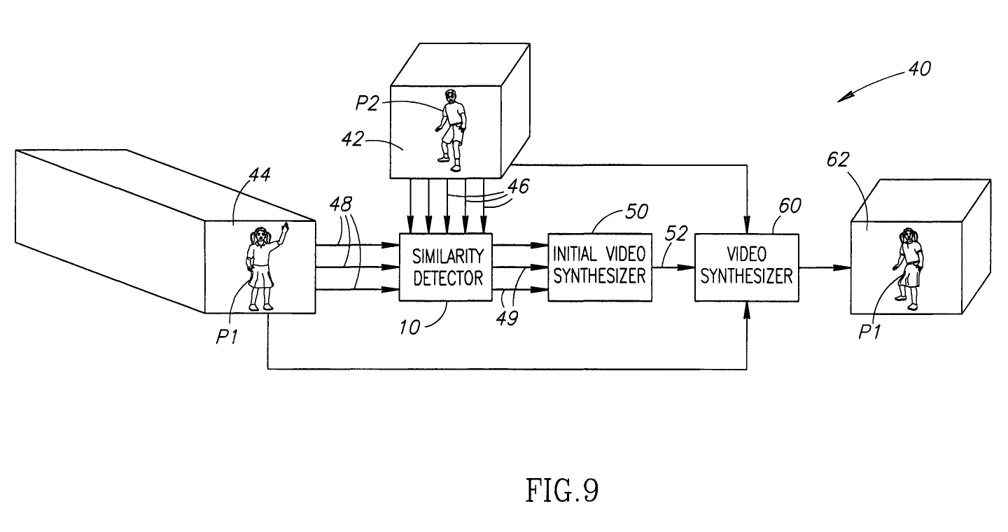

In a further embodiment of the present invention, shown in FIG. 9 to which reference is now made, similarity detector 10 may form part of an imitation unit 40, which may synthesize a video of a person P1 (a female) performing or imitating the movements of another person P2 (a male). In this embodiment, imitation unit 40 may receive a “guiding” video 42 of person P2 performing some actions, and a reference video 44 of different actions of person P1. Database video 44 may be a single video or multiple video sequences of person P1. Imitation unit 40 may comprise similarity detector 10, an initial video synthesizer 50 and a video synthesizer 60.

Guiding video 42 may be divided into small, overlapping space-time video chunks 46 (or patches), each of which may have a location (x,y) in space and a timing (t) along the video. Thus, each chunk is defined by (x,y,t).

Similarity detector 10 may initially match each chunk 46 of guiding video 42, to small space-time video chunks 48 from reference video 44. This may be performed at a relatively coarse resolution.

Initial video synthesizer 50 may string together the matched reference chunks, labeled 49, according to the location and timing (x,y,t) of the guiding chunks 48 to which they were matched by detector 10. This may provide an “initial guess” 52 of what the synthesized video will look like, though the initial guess may not be coherent. It is noted that the synthesized video is of the size and length of the guiding video.

Video synthesizer 60 may synthesize the final video, labeled 62, from initial guess 52 and reference video 44 using guiding video 42 to constrain the synthesis process. Synthesized video 62 may satisfy three constraints:

a. Every local space-time patch (at multiple scales) of synthesized video 62 may be similar to some local space-time patch 48 in reference video 44;

b. Globally, all of the patches may be consistent with each other, both spatially and temporally; and

c. The self-similarity descriptor of each patch of synthesized video 62 may be similar to the descriptor of the corresponding patch (in the same space-time locations (x,y,t)) of guiding video 42.

The first two constraints may be similar to the “visual coherence” constraints of the video completion problem discussed in the article by Y. Wexler, E. Shechtman and M. Irani, Space-Time Video Completion, Computer Vision and Pattern Recognition 2004 (CVPR'04), which article is incorporated herein by reference. The last constraint may be fulfilled by measuring the distance between self-similarity descriptors of patches from synthesized video 62 and the corresponding descriptors, which may be constant, from guiding video 42. Video synthesizer 60 may combine these three constraints into one objective function and may solve an optimization problem with an iterative algorithm similar to the one in the article by Y. Wexler, et al. The main steps of this iterative process may be:

1) For each pixel of current output video 62, collect all patches of video 62 that contain this pixel and search for the most similar patches in reference video 44, where the similarity may be a weighted combination of:

a) the similarity of the patches' appearance (for example, by calculating the simple sum of differences (SSD) on the color values in the L*a*b* space of the corresponding patches); and

b) how similar the self-similarity descriptors of patches of guiding video 42 are to the self-similarity descriptors of the patches in reference video 44 at the matching locations to the patches of guiding video 42.

2) After finding this collection of similar patches from reference video 44, video synthesizer 60 may compute a Maximum Likelihood estimation of the color of the pixel as a weighted combination of corresponding colors in those patches, as described in the article by Y. Wexler, et al.

3) Video synthesizer 60 may update the colors of all pixels within the current output video 62 with the color found in step 2.

4) Video synthesizer 60 may continue until convergence of the objective function is reached.

Video synthesizer 60 may perform the process in a multi-scale operation (i.e. using a space-time pyramid), from the coarsest to the finest space-time resolution, as described in the article by Y. Wexler, et al.

It will be appreciated that imitation unit 40 may operate on video sequences, as described hereinabove, or on still images. In the latter, the guiding signal is an image and the reference is a database of images and imitation unit 40 may operate to create a synthesized image having the structure of the elements (such as poses of people) of the guiding image but using the elements of the reference signal.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
matching at least portions of first and second signals using local self-similarity descriptors of said signals,
wherein said matching comprises:
computing a local self-similarity descriptor for each one of at least a portion of points in said first signal;
forming a query ensemble of said descriptors for said first signal; and
seeking an ensemble of descriptors of said second signal which matches said query ensemble of descriptors.

2. The method according to claim 1 and wherein said ensemble is at least one of the following: a geometric organization of said descriptors, an empirical distribution of said descriptors, a set of representative descriptors derived from said descriptors, a quantized representation of said descriptors, a subset of said descriptors, geometric layouts of said descriptors and a single descriptor.

3. The method according to claim 2 and wherein said ensemble captures the relative positions of said descriptors while accounting for local geometric deformations.

4. The method according to claim 1 and wherein said computing comprises generating said local self-similarity descriptor between a patch of said signal to a region within said signal.

5. The method according to claim 4 wherein said region is a region containing said patch.

6. The method according to claim 4 and wherein said generating comprises calculating a patch-region similarity function.

7. The method according to claim 6 and wherein said generating also comprises transforming said patch-region similarity function into a compact representation.

8. The method according to claim 7 and wherein said compact representation is binned.

9. The method according to claim 8 and wherein the bins of said binned representation are radially increasing in size.

10. The method according to claim 7 and wherein said transforming comprises quantizing values of said similarity function.

11. The method according to claim 4 and wherein said each said patch and region is described by local signal descriptors and said local signal descriptors are at least one of the following types of descriptors: intensity values, color representation values, gradient values, filter responses, SIFT descriptors, histograms of filter responses, Gaussian blur descriptors and empirical distributions of features.

12. The method according to claim 6 and wherein said calculating comprises computing a function of at least one of the following types of measures: a sum of squared differences, a Mahalanobis distance, a sum of absolute differences, a correlation, a normalized correlation, mutual information, a distance measure between empirical distributions, a distance measure between local region descriptors and a distance between feature vectors.

13. The method according to claim 6 and also comprising filtering out non-informative descriptors to generate a subset of descriptors.

14. The method according to claim 1 and wherein at least one of said signals is at least one of the following: an image, a video sequence, an animation, fMRI data, MRI, CT, X-ray, ultrasound, medical data, satellite images, hyperspectral images, a map, a diagram, a sketch, audio signals, a CAD model, 3D visual data, range data, DNA sequences and an n-dimensional signal, where n is 1 or greater.

15. The method according to claim 1 and wherein one of said signals is a sketch and the other said signal is an image.

16. The method according to claim 15 and wherein said sketch is one of the following: a schematic sketch, a diagram, a drawing, a map, a cartoon, a pattern, a painting and an illustration.

17. The method according to claim 15 wherein said sketch is a map of a region and said other signal is an image including said region.

18. The method according to claim 1 and also comprising using the output of said matching to detect changes between said first and said second signals.

19. The method according to claim 1 and also comprising using the output of said matching to detect correspondences of at least one point between said first and second signals.

20. The method according to claim 1 and also comprising using the output of said matching to align said first signal with said second signal.

21. The method according to claim 1 and also comprising using the output of said matching to detect common information between said first and second signals.

22. The method according to claim 1 and wherein one of said signals is an animation and the other said signal is a video sequence.

23. The method according to claim 1 and wherein said computing comprises estimating said self-similarity descriptors on a dense grid of points.

24. The method according to claim 1 and wherein said computing comprises estimating said self-similarity descriptors at multiple scales.

25. The method according to claim 1 wherein said signals are video sequences and also comprising using the output of said matching to detect an action present in said first signal within said second signal.

26. The method according to claim 1 wherein said signals are images and also comprising using the output of said matching to detect an object present in said first signal within said second signal.

27. The method according to claim 1 and wherein said second signal is a database of signals and also comprising using the output of said matching to retrieve signals from said database.

28. The method according to claim 26 and wherein said object is a face and said matching is used to detect faces in said second signal.

29. The method according to claim 26 and wherein said object is at least one of: a character, a letter, a digit, a word, a sentence, a symbol, a typed character and a hand-written character.

30. The method according to claim 1 wherein said first signal is a guiding signal and said second signal is a reference signal and also comprising synthesizing a new signal with elements similar to those of said guiding signal synthesized from portions of said reference signal.

31. The method according to claim 30 wherein said signals are video sequences and said elements are actions.

32. The method according to claim 30 wherein said signals are images and said elements are objects.

33. The method according to claim 30 and wherein said synthesizing comprises:
matching chunks of said guiding signal to chunks of said reference signal;
concatenating said matched reference chunks wherein said concatenating is constrained by the relative location of said matched guiding chunks; and
synthesizing said new signal at least from said concatenated reference chunks.

34. The method according to claim 1 and comprising using the output of said matching for at least one of: image categorization, object classification, object recognition, image segmentation, image alignment, video categorization, action recognition, action classification, video segmentation, video alignment, signal alignment, multi-sensor signal alignment, multi-sensor signal matching and optical character recognition.

35. An apparatus comprising:
a similarity detector to match at least portions of first and second signals using local self-similarity descriptors of said signals
wherein said similarity detector comprises:
a descriptor calculator to compute a local self-similarity descriptor for each one of at least a portion of points in said first signal; and
a descriptor ensemble matcher to form a query ensemble of said descriptors for said first signal and to seek an ensemble of descriptors of said second signal which matches said query ensemble of descriptors.

36. The apparatus according to claim 35 and wherein said ensemble is at least one of the following: a geometric organization of said descriptors, an empirical distribution of said descriptors, a set of representative descriptors derived from said descriptors, a quantized representation of said descriptors, a subset of said descriptors, geometric layouts of said descriptors and a single descriptor.

37. The apparatus according to claim 35 and wherein said descriptor calculator comprises a self-similarity generator to generate said local self-similarity descriptor between a patch of said signal to a region within said signal.

38. The apparatus according to claim 37 wherein said region is a region containing said patch.

39. The apparatus according to claim 37 and wherein said self-similarity generator comprises a function generator to generate a patch-region similarity function.

40. The apparatus according to claim 39 and wherein said function generator comprises a transformer to transform said patch-region similarity function into a compact representation.

41. The apparatus according to claim 40 and wherein said compact representation is binned.

42. The apparatus according to claim 41 and wherein the bins of said binned representation are radially increasing in size.

43. The apparatus according to claim 40 and wherein said transformer comprises a quantizer to quantize values of said similarity function.

44. The apparatus according to claim 37 and wherein said each said patch and region is described by local signal descriptors and said local signal descriptors are at least one of the following types of descriptors: intensity values, color representation values, gradient values, filter responses, SIFT descriptors, histograms of filter responses, Gaussian blur descriptors and empirical distributions of features.

45. The apparatus according to claim 39 and wherein said function generator comprises a similarity measure generator to compute a function of at least one of the following types of measures: a sum of squared differences, a Mahalanobis distance, a sum of absolute differences, a correlation, a normalized correlation, mutual information, a distance measure between empirical distributions, a distance measure between local region descriptors and a distance between feature vectors.

46. The apparatus according to claim 39 and wherein said descriptor calculator comprises a filter to filter out non-informative descriptors to generate a subset of descriptors.

47. The apparatus according to claim 35 and wherein at least one of said signals is at least one of the following: an image, a video sequence, an animation, fMRI data, MRI, CT, X-ray, ultrasound, medical data, satellite images, hyperspectral images, a map, a diagram, a sketch, audio signals, a CAD model, 3D visual data, range data, DNA sequences and an n-dimensional signal, where n is 1 or greater.

48. The apparatus according to claim 35 and wherein one of said signals is a sketch and the other said signal is an image:

49. The apparatus according to claim 48 and wherein said sketch is one of the following: a schematic sketch, a diagram, a drawing, a map, a cartoon, a pattern, a painting and an illustration.

50. The apparatus according to claim 48 wherein said sketch is a map of a region and said other signal is an image including said region.

51. The apparatus according to claim 35 and also comprising a change detector to use the output of said similarity detector to detect changes between said first and said second signals.

52. The apparatus according to claim 35 and also comprising correspondence detector to use the output of said matching to detect correspondences of at least one point between said first and second signals.

53. The apparatus according to claim 35 and also comprising an aligner to use the output of said matching to align said first signal with said second signal.

54. The apparatus according to claim 35 and also comprising a commonality detector to use the output of said similarity detector to detect common information between said first and second signals.

55. The apparatus according to claim 35 and wherein one of said signals is an animation and the other said signal is a video sequence.

56. The apparatus according to claim 35 wherein said signals are video sequences and also comprising an action detector to use the output of said similarity detector to detect an action present in said first signal within said second signal.

57. The apparatus according to claim 35 wherein said signals are images and also comprising an object detector to use the output of said similarity detector to detect an object present in said first signal within said second signal.

58. The apparatus according to claim 35 and wherein said second signal is a database of signals and also comprising a signal retriever to use the output of said similarity detector to retrieve signals from said database.

59. The apparatus according to claim 57 and wherein said object is a face and said similarity detector is used to detect faces in said second signal.

60. The apparatus according to claim 57 and wherein said object is at least one of: a character, a letter, a digit, a word, a sentence, a symbol, a typed character and a hand-written character.

61. The apparatus according to claim 35 wherein said first signal is a guiding signal and said second signal is a reference signal and also comprising a synthesizer to synthesize a new signal with elements similar to those of said guiding signal synthesized from portions of said reference signal.

62. The apparatus according to claim 61 wherein said signals are video sequences and said elements are actions.

63. The apparatus according to claim 61 wherein said signals are images and said elements are objects.

64. The apparatus according to claim 61 and wherein said synthesizer comprises:
said similarity detector to match chunks of said guiding signal to chunks of said reference signal;
an initial video synthesizer to concatenate said matched reference chunks wherein said concatenating is constrained by the relative location of said matched guiding chunks; and
a second synthesizer to synthesize said new signal at least from said concatenated reference chunks.

65. The apparatus according to claim 35 and comprising an output provider to provide the output of said similarity detector for at least one of: image categorization, object classification, object recognition, image segmentation, image alignment, video categorization, action recognition, action classification, video segmentation, video alignment, signal alignment, multi-sensor signal alignment, multi-sensor signal matching and optical character recognition.

66. A method for generating a local self-similarity descriptor, the method comprising:
calculating a patch-region similarity function between a patch of a signal to a region within a signal; and
transforming said patch-region similarity function into a binned representation, wherein the bins of said binned representation are radially increasing in size.

67. An apparatus for generating a local self-similarity descriptor, the apparatus comprising:
a similarity generator to calculate a patch-region similarity function between a patch of a signal to a region within a signal; and
a descriptor generator to transform said patch-region similarity function into a binned representation, wherein the bins of said binned representation are radially increasing in size.
